(19) United States
(12) Patent Application Publication
(10) Pub. No.: US 2025/0030474 A1
(43) Pub. Date: Jan. 23, 2025

(54) BEAM SELECTION FOR WIRELESS COMMUNICATION

(71) Applicant: Telefonaktiebolaget LM Ericsson (publ), Stockholm (SE)

(72) Inventor: Bengt-Erik OLSSON, HOVÅS (SE)

(73) Assignee: Telefonaktiebolaget LM Ericsson (publ), Stockholm (SE)

(21) Appl. No.: 18/708,699

(22) PCT Filed: Nov. 10, 2021
(86) PCT No.: PCT/EP2021/081172

§ 371 Date: May 9, 2024

(51) Int. Cl. H04B 7/06; H04B 7/04

(52) U.S. Cl. CPC H04B 7/06952; H04B 7/04013; H04B 7/0632

(57) ABSTRACT

A wireless communication method is disclosed. The method is performed by a radio access node for selection of a beam for communication with a device. The selection is from a plurality of available beams. The method comprises acquiring channel quality metrics for available beams providing coverage for an area of location of the device, and selecting one of the available beams based on the acquired channel quality metrics. At least one of the available beams is associated with a radio reflector which is specifically arranged to enable the associated beam to provide coverage for the area of location of the device via the radio reflector. For example, two or more available beams may be associated with respective radio reflectors, each radio reflector being specifically arranged to enable the respectively associated beam to provide coverage for the area of location of the device via the radio reflector. Corresponding computer program product, apparatus, radio access node, and wireless communication system are also disclosed.

### TECHNICAL FIELD

The present disclosure relates generally to the field of wireless communication using beam-forming. More particularly, it relates to beam selection for such wireless communication.

### BACKGROUND

Beam-forming is a well-known technique commonly applied in wireless communication. Some potential benefits of beam-forming include improved interference control and increased signaling range. The latter is particularly useful for relatively high communication frequencies, such as millimeter wave communications (at 1 GHz and above). For example, beam-forming is a prominent aspect for fifth generation (5G) communication, sixth generation (6G) communication, and beyond.

Application of beam-forming communication includes selection of appropriate beam(s) among a collection of available beams; to enable proper communication between two communication entities (e.g., a radio access node and a user device). This process typically involves overhead signaling (e.g., reference signaling for measurements on candidate beams) which can be substantial, and thereby impair performance (e.g., in terms of throughput, latency, etc.). Furthermore, failure to timely select appropriate beam(s) may cause connection loss.

In scenarios where one or more obstacles are present that obstruct or block the radio signal between the two communication entities, appropriate and timely beam selection may be particularly cumbersome. This is especially prominent for relatively high communication frequencies.

Therefore, there is a need for alternative approaches to beam selection.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages. A first aspect is a wireless communication method performed by a radio access node for selection of a beam for

communication with a device, wherein the selection is from a plurality of available beams.

The method comprises acquiring channel quality metrics for available beams providing coverage for an area of location of the device, wherein at least one of the available beams is associated with a radio reflector which is specifically arranged to enable the associated beam to provide coverage for the area of location of the device via the radio reflector, and selecting one of the available beams based on the acquired channel quality metrics.

In some embodiments, two or more available beams are associated with respective radio reflectors, each radio reflector being specifically arranged to enable the respectively associated beam to provide coverage for the area of location of the device via the radio reflector.

In some embodiments, the two or more available beams are enabled by the respective radio reflectors to provide redundancy coverage for the area of location of the device.

In some embodiments, respective areas of the coverage provided by the two or more available beams via the respective radio reflector are at least partially overlapping.

In some embodiments, different radio reflectors are associated with different available beams for coverage of the area of location of the device.

In some embodiments, at least one radio reflector has imperfections causing partial impairment of the coverage provided by the associated beam for the area of location of the device.

In some embodiments, the selection is comprised in a beam tracking procedure.

In some embodiments, the beam tracking procedure comprises—for an active beam currently used for communication with the device—determining available beams that provide coverage adjacent to, and/or overlapping, the coverage of the active beam. The determined available beams are used as the available beams providing coverage for the area of location of the device.

In some embodiments, the method further comprises acquiring information for at least one available beam, the information indicative of beam coverage and/or radio reflector association.

In some embodiments, the information comprises associations between beam pairs that provide adjacent and/or overlapping and/or coinciding coverage.

In some embodiments, the information is acquired at installation of the radio reflector and/or of the radio access node.

In some embodiments, the information is acquired and/or updated by collecting statistics regarding one or more of: which beam pairs are involved in successful beam switching events, which beam pairs are involved in unsuccessful beam switching events, and which beam pairs are involved in connection re-establishment.

In some embodiments, the communication with the device uses frequencies above 1 GHz.

In some embodiments, a radio signaling line of sight between the radio access node and the area of location of the device is obstructed.

In some embodiments, the radio reflector extends throughout a Fresnel zone for the radio access node and the device.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for wireless communication by a radio access node, the apparatus being for selection of a beam for communication with a device, wherein the selection is from a plurality of available beams.

The apparatus comprises controlling circuitry configured to cause acquisition of channel quality metrics for available beams providing coverage for an area of location of the device, wherein at least one of the available beams is associated with a radio reflector which is specifically arranged to enable the associated beam to provide coverage for the area of location of the device via the radio reflector, and selection of one of the available beams based on the acquired channel quality metrics.

A fourth aspect is a radio access node comprising the apparatus of the third aspect.

A fifth aspect is a wireless communication system comprising the apparatus of the third aspect and/or the radio access node of the fourth aspect, and at least one radio reflector specifically arranged to enable an associated beam to provide coverage for the area of location of the device via the radio reflector.

In some embodiments, the at least one radio reflector comprises a plurality of radio reflectors, each radio reflector being specifically arranged to enable a respectively associated beam to provide coverage for the area of location of the device via the radio reflector.

In some embodiments, the system is for deployment in a geographically bounded communication environment, such as an industrial environment.

In some embodiments, any of the above aspects may additionally have features identical with or corresponding to any of the various features as explained above for any of the other aspects.

An advantage of some embodiments is that alternative approaches to beam selection are provided.

An advantage of some embodiments is that beam selection is improved compared to other approaches. For example, the time and/or overhead signaling needed to select appropriate beam(s) may be reduced compared to other approaches.

An advantage of some embodiments is that a more robust communication link is provided compared to other approaches.

An advantage of some embodiments is that the probability of connection loss is reduced compared to other approaches.

An advantage of some embodiments is that time to re-establishment after connection loss is reduced compared to other approaches.

An advantage of some embodiments is that coverage is improved compared to other approaches.

An advantage of some embodiments is that interference control is improved compared to other approaches.

An advantage of some embodiments is that communication performance is improved (e.g., in terms of throughput, latency, etc.) compared to other approaches.

An advantage of some embodiments is that the requirements on radio reflector perfection (e.g., in terms of flatness, mechanical stability, etc.) are relaxed compared to other approaches.

An advantage of some embodiments is that multiple small reflectors may be employed instead of a single large reflector, while avoiding creation of interference (or at least keeping interference caused at a relatively low level). This may be beneficial since large reflectors are typically cumbersome to manufacture and/or deploy.

According to some embodiments, one or more of the above (or other) advantages may be achieved for at least some communication scenarios (e.g., scenarios where one or more obstacles are present that obstruct or block the radio signal between two communication entities, and/or scenarios where relatively high communication frequencies are used).

Generally, when relatively high communication frequencies are referred to herein, examples include millimeter wave communications (at 1 GHz and above)—in particular communication in the 28 GHz frequency band and/or communication in the 39 GHz frequency band.

### BRIEF DESCRIPTION OF THE DRAWINGS

Further objects, features and advantages will appear from the following detailed description of embodiments, with reference being made to the accompanying drawings. The drawings are not necessarily to scale; emphasis instead being placed upon illustrating the example embodiments.

FIG. 1 is a pair of schematic drawings illustrating example scenarios for some embodiments;

FIG. 2 is a pair of schematic drawings illustrating example radio reflectors according to some embodiments;

FIG. 3 is a schematic drawing illustrating an example scenario according to some embodiments;

FIG. 4 is a schematic drawing illustrating an example scenario according to some embodiments;

FIG. 5 is a schematic drawing illustrating an example scenario according to some embodiments;

FIG. 6 is a pair of schematic drawings illustrating an example beam tracking scenario according to some embodiments;

FIG. 7 is a flowchart illustrating example method steps according to some embodiments;

FIG. 8 is a schematic block diagram illustrating an example apparatus according to some embodiments; and

FIG. 9 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

Generally, when coverage is referred to herein it is understood to be wireless communication coverage. To provide coverage may, thus, be understood as enabling communication for a device residing in the coverage area.

Even if example problems and embodiments are described in the context of, and using terminology from, Third Generation Partnership Project (3GPP) standardization, it should be noted that the disclosure herein may be equally applicable in other contexts where beam selection is applied.

Fading is a well-known characteristic of wireless communication networks. At relatively low communication frequencies, reflections and diffractions typically provide a rich propagation channel with many paths, which enables diversity receivers to mitigate destructive interference due to fading. Furthermore, relatively high power levels for transmission, sensitive receivers, and low free space path loss (FSPL) can provide for relatively large power margins. Thus, the user typically experiences uninterrupted coverage in such situations.

However, when relatively high communication frequencies are used (e.g., the 5G frequencies on millimeter wave, such as the 28 GHz and 39 GHz frequency bands, and the even higher 6G frequencies), the coverage situation will typically be different. The reason(s) for deteriorated coverage may be one or more of the following: losses in reflections and diffractions being higher (providing a more diluted propagation channel with less paths), power levels for transmission being lower, receiver sensibility being worse, and FSPL being higher.

Therefore, there is typically only one propagation path present at the receiver in line-of-sight (LOS) scenarios, which (if unobstructed) may create a very stable, high performing, propagation path. However, in non-line-of-sight (NLOS) scenarios, there may typically be very few (e.g., only one, or no) propagation paths present at the receiver—possibly supplemented by the associated ground reflections available. This type of situation can make the interference difficult to handle since it is relatively stable, which makes locations with bad coverage (e.g., due to destructive interference) more prominent. Thus, the connection may often be lost in areas with such bad coverage.

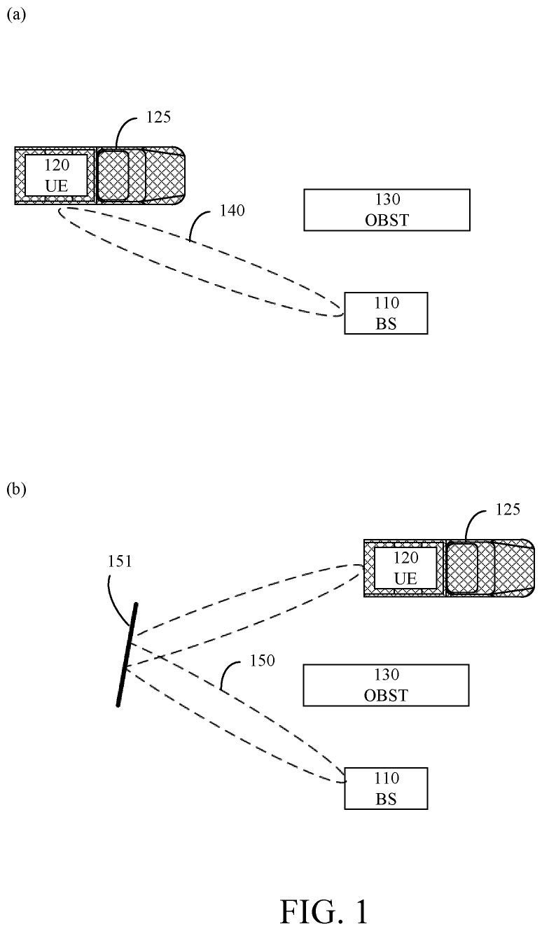

A radio reflector (e.g., a fixed reflector panel) may be used to improve coverage in NLOS areas by reflecting power from a LOS location into the NLOS area. This is exemplified in FIG. 1.

FIG. 1 schematically illustrates an example scenario where some embodiments may be applicable, namely a scenario where an obstacle (OBST) 130 is present that may obstruct or block the radio signal between two communication entities. In the example of FIG. 1, the two communication entities are a base station (BS) 110 and a user equipment (UE) 120 carried by a vehicle 125.

For example, the UE 120 may be mounted in the vehicle 125 (e.g., to be used for remotely controlling the vehicle 125). The vehicle 125 may, for example, be a construction vehicle, a drone, a robot, or similar. Alternatively or additionally, the example scenario may reside within a geographically bounded environment, such as, for example, an industrial environment, a construction site, a factory building, or a non-public property.

It should be noted that any context for the UE may be relevant. Thus, that the UE 120 is carried by the vehicle 125 is merely an example.

The example scenario of FIG. 1 is illustrated using two schematic situations; situation (a) and situation (b). In situation (a), a beam 140 can be used for line-of-sight communication between the BS 110 and the UE 120. In situation (b), the vehicle has moved to another location compared to situation (a), thereby causing the obstacle 130 to reside between the BS 110 and the UE 120. Thus, there is no beam that can be used for line-of-sight communication between the BS 110 and the UE 120 in situation (b). One possible solution to this problem is to utilize a radio reflector 151 that causes a beam 150 to be reflected such that it can be used for communication between the BS 110 and the UE 120.

Generally, a radio reflector can be any surface that at least partially reflect a radio signal (e.g., a building exterior). However, the radio reflectors utilized in the context of this application are specifically arranged to enable coverage via the radio reflector for an area where line-of-sight communication is not possible.

Thus, according to some embodiments, radio reflectors are meant to especially encompass surfaces specifically designed to reflect radio signals; typically radio signals within a certain frequency range.

Alternatively or additionally, according to some embodiments, radio reflectors are meant to especially encompass surfaces that are installed at a specific location, and/or with a specific orientation, that enables a beam to provide coverage via the radio reflector for the area where line-of-sight communication is not possible.

Yet alternatively or additionally, according to some embodiments, radio reflectors are meant to especially encompass surfaces with a size that is particularly suitable for reflection of radio signals. For example, a radio reflector may have a surface area that is configured to extend over a cross section (or at least a substantial part thereof) of a Fresnel zone between two communication entities. In this context, it may be noted that the size of a cross section of a Fresnel zone is reduced when the communication frequency is increased. Hence, for relatively high communication frequencies, it is possible to use relatively small radio reflectors. For example, the Fresnel zone typically has a cross section with a diameter around, or below, 1 meter at 28 GHz (5G small cell deployment).

Example radio reflectors include flat radio reflecting surfaces and convex (or concave) radio reflecting surfaces. Alternatively or additionally, example radio reflectors include plain radio mirrors (e.g., a metal sheet) and reflecting intelligent surfaces (RIS). Various implementations of reflecting intelligent surfaces exist, and any suitable implementation may be applicable in the context described herein. A reflecting intelligent surface may, for example, be defined as a device where reflection properties are configured for specific input/output angles, which can sometimes be dynamically adjusted. In some implementations, a reflecting intelligent surface may comprise a relatively large plurality of reflecting elements, the reflecting angles of which are independently and dynamically controllable.

An ideal radio reflector (e.g., a perfectly flat radio mirror) provide a radio path between two locations by means of reflection in a single location on the radio reflector surface that fulfils the requirement that the input and output angels are equal. Such a radio reflector can, in principle, provide very stable coverage in a NLOS area. The larger the radio reflector is, the larger the possible coverage area is.

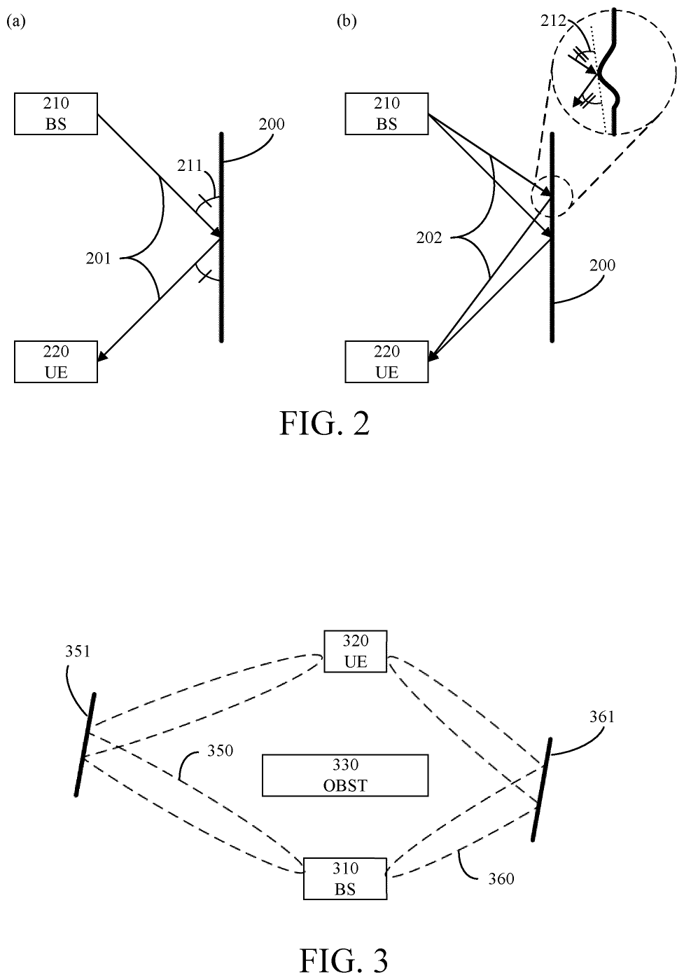

In practice, however, the radio reflector is typically not ideal. Therefore, the requirement that the input and output angels are equal can be fulfilled at multiple locations on the radio reflector surface, which provides more than one reflected radio paths that may interfere (constructively or destructively) with each other at the intended receiver. This is exemplified in FIG. 2.

FIG. 2 schematically illustrates an example radio reflector 200 according to some embodiments. For example, the radio reflector 200 may illustrate any of the radio reflectors shown in FIGS. 1, and 3 through 6.

Situation (a) of FIG. 2 illustrates that the radio reflector 200 is arranged to provide a (first) signal path 201 from the BS 210 to the UE 220 via the reflection angle 211. Situation (b) of FIG. 2 illustrates that the radio reflector 200 may additionally provide a (second) signal path 202 from the BS 210 to the UE 220 via the reflection angle 212, wherein the reflection angle 212 is caused by an imperfection of the radio reflector 200. For example, the imperfection may be a dent or any other deviation from the desired surface form.

At the UE 220, the signal paths 201 and 202 may combine constructively or destructively. When combining is destructive, the reflector 200 may fail to provide coverage for the UE 220, even if it was specifically arranged to enable coverage for the area of location of the UE 220.

It may be noted that, for relatively high communication frequencies, even relatively small imperfections may cause additional reflections. Hence, the problem of radio reflector imperfections degrading coverage becomes increasingly prominent as the communication frequency increases.

It should also be noted that there may be more than one (e.g., a plurality) of imperfections of the radio reflector; causing a corresponding number of additional (second) signal paths to contribute to constructive/destructive combining.

Thus, when the requirement that the input and output angels are equal is fulfilled in more than one location on the radio reflector, the reflected signal seen by the receiver is affected by interference between the resulting radio paths. The interference result typically depends on the phase relation between the different reflected radio paths, which varies between different locations of the receiver.

Typically, large reflectors are more cumbersome than small reflectors to manufacture and/or deploy without imperfections (or with tolerable imperfections).

According to some scenarios, the tolerable phase difference may be capped at π/8 radians for reflections within the Fresnel zone to avoid unwanted interference. At frequencies around 28 GHz, this corresponds to a tolerable flatness variation for the radio reflector of less than about 0.6 mm, which can be very difficult to achieve ; specifically over a large reflector panel.

It should be noted that there may, additionally or alternatively, be other reasons for destructive interference than radio reflector imperfections; all of which may be relevant in the context of various embodiments presented herein.

Hence, referring back to situation (b) of FIG. 1, it is noted that if the radio reflector 151 has imperfections, combining effects (as exemplified in connection with FIG. 2) might result in unreliable coverage for the UE 120. For example, some locations intended to be covered by beam 150 via radio reflector 151 may experience weak (or no) coverage due to destructive interference from signal paths caused by the imperfections. Additionally, the coverage at a location may fluctuate due to minor movements of the radio reflector (e.g., due to vibrations, wind, temperature changes, etc.) causing the signal paths from the radio reflector to combine differently.

Interference caused by imperfections of a radio reflector typically occurs over very wide bandwidth since the difference in path length between the interfering paths is very short. Thus, frequency selective interference mitigation techniques (e.g., dynamically using different frequency ranges depending on coverage) will not be efficient. Furthermore, interference mitigation techniques using diversity receivers where received signals from two or more antennas separated in space are combined may not be sufficiently effective, since the antenna separation may be limited by the size of the receiving device (e.g., a UE) and the areas with poor coverage may be larger than the antenna separation. Thus, other approaches to mitigate situations with destructive interference might be beneficial.

FIG. 3 schematically illustrates an example scenario where some embodiments may be applicable. In similarity with situation (b) in FIG. 1, an obstacle (OBST) 330 obstructs or blocks the radio signal between two communication entities; a base station (BS) 310 and a user equipment (UE) 320. Thus, there is no beam that can be used for line-of-sight communication between the BS 310 and the UE 320.

In contrast to situation (b) of FIG. 1, two radio reflectors 351, 361 are used in FIG. 3 to solve the problem caused by the obstacle 330. The radio reflector 351 causes a beam 350 to be reflected toward the area of location of the UE 320, and the radio reflector 361 causes a different beam 360 to be reflected toward the area of location of the UE 320. Using two radio reflectors may be beneficial to mitigate the problem with unreliable coverage for the UE 320 when any of the radio reflectors has imperfections, since the beams 350, 360 and their associated radio reflectors provide redundancy coverage for the area of location of the UE 320. Thus, when/where there is weak (or no) coverage provided by beam 350, the BS 310 may switch to beam 360 and vice versa. Consequently, the probability of connection loss is reduced.

It should be noted that more than two radio reflectors (each associated with a different beam) may be applied to provide further redundancy. Alternatively or additionally, other radio reflectors and/or other associated beams may be applied to provide coverage for other areas of location.

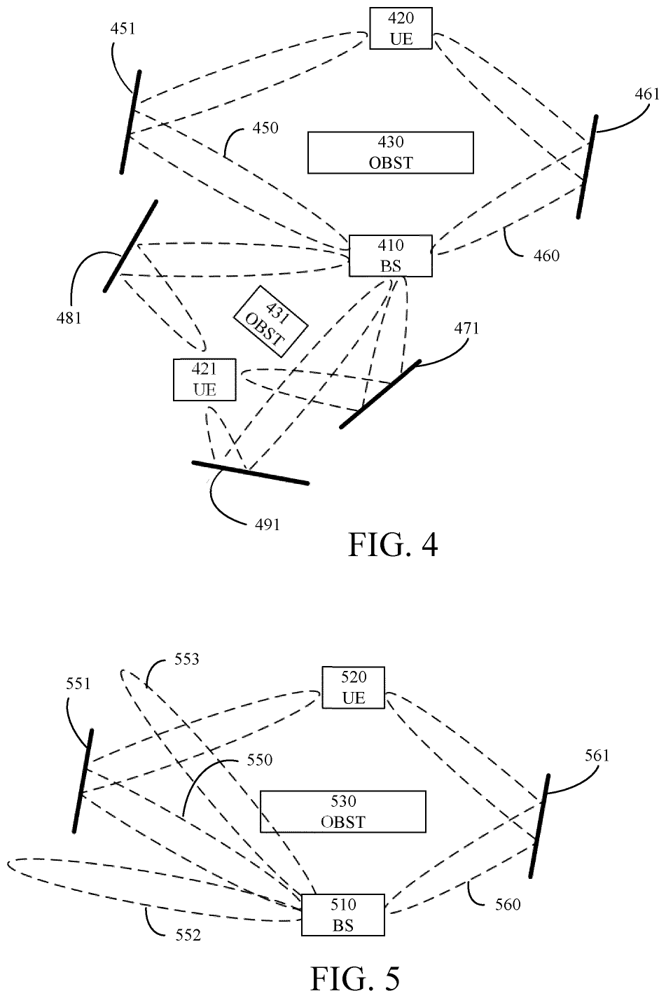

FIG. 4 schematically illustrates an example scenario where some embodiments may be applicable.

In similarity with FIG. 3, a first obstacle (OBST) 430 obstructs or blocks the radio signal between two communication entities; a base station (BS) 410 and a first user equipment (UE) 420. Two radio reflectors 451, 461 are used in FIG. 4 to solve the problem caused by the obstacle 430, and to mitigate any problem with unreliable coverage for the UE 420 due to imperfections of the radio reflectors. The radio reflector 451 causes a beam 450 to be reflected toward the area of location of the UE 420, and the radio reflector 461 causes a different beam 460 to be reflected toward the area of location of the UE 420.

Also illustrated is a second obstacle (OBST) 431, which obstructs or blocks the radio signal between the base station (BS) 410 and a second user equipment (UE) 421. Three radio reflectors 471, 481, 491 are used in FIG. 4 to solve the problem caused by the obstacle 431, and to mitigate any problem with unreliable coverage for the UE 421 due to imperfections of the radio reflectors.

Generally, it should be noted that one reflector may be associated with two or more beams, wherein each associated beam provides coverage for a respective area of location via the radio reflector. Typically, different beams associated with the same radio reflector provides coverage for different areas of location via the radio reflector (e.g., corresponding to different reflection angles for the different beams at the radio reflector).

Using more than one reflector in a deployment may generally entail a risk of creating interference due to combination of reflections. Application of some embodiments can mitigate this problem (e.g., by properly selecting a suitable beam, and thereby a suitable reflector, for coverage of an area of location). Thus, embodiments presented herein enable use of multiple reflectors to provide reliable coverage. This may further enable use of relatively small reflectors instead of a single large reflector.

Approaches for beam selection include selection of initial beam (e.g., at connection setup) as well as beam tracking. To reduce the time and/or overhead signaling needed to select appropriate beam(s) it is possible to probe only a subset of all available beams. Beams of such a subset may be denoted as candidate beams. Probing may, for example, involve reference signaling (e.g., channel state information reference signals-CSI-RS) for measurements on candidate beams. It should be noted, however, that any suitable probing approach may be applicable in the context of the approached presented herein.

Selection of initial beam may typically commence by probing a few wide beams to determine an approximate direction (e.g., an angular interval of directions corresponding to a wide beam). Then, narrow beams within that angular interval of directions may be probed as candidate beams to determine which beam should be initially selected.

Selection for beam tracking may typically comprise considering beams angularly adjacent to the currently used beam as candidate beams, and probing such adjacent beams to determine which beam should be selected when performance of the currently used beam deteriorates (e.g., when its channel quality metric falls below a threshold, or when its throughput decreases).

Hence, the concept of which beams are spatially close to each other in the angular dimension is used for both initial beam selection (e.g., beams within the angular interval of directions of the wide beam are considered spatially close to each other) and beam tracking (e.g., the currently used beam and beams angularly adjacent to the currently used beam are considered spatially close to each other).

However, using one or more radio reflectors as exemplified above may render the concept of which beams are spatially close to each other in the angular dimension less accurate for beam selection. It may be more beneficial to use a concept of which beams provide coverage areas close to each other. Example definitions of coverage areas considered to be close to each other include coinciding coverage areas, overlapping coverage areas, adjacent coverage areas, and coverage areas within a certain—typically larger—area (e.g., a sector area corresponding to a wide beam).

Thus, when radio reflectors are used, the candidate beams for probing may be determined as beams providing coverage areas close to each other instead of (or in addition to) beams that are spatially close to each other in the angular dimension. Knowledge of which beams provide coverage areas close to each other may take any suitable form. For example, the knowledge may be provided as an association between two or more of a beam, a radio reflector, and an area of location. Alternatively or additionally, the knowledge may be provided by associating a beam with its virtually adjacent beams (the ones that have coinciding/overlapping/adjacent coverage areas) instead of—or in addition to—the association with its adjacent beams (the ones that are spatially adjacent to each other in the angular dimension).

Knowledge of which beams provide coverage areas close to each other may be acquired in various ways. Examples include configuration of a radio access node (e.g., using manual input, or control signaling) in connection with installation of a radio reflector, configuration of the radio access node (e.g., using manual input, or control signaling) in connection with installation of the radio access node, and determination (e.g., using machine learning—ML; which may be based on synchronization signal block—SSB—or massive traffic beam probing) by the radio access node based on beam usage statistics.

Using the concept of which beams provide coverage areas close to each other for selection of initial beam may still commence by probing a few wide beams to determine an approximate direction (e.g., an angular interval of directions corresponding to a wide beam). Then, narrow beams with coverage areas within a sector area corresponding to the wide beam—possibly together with narrow beams within that angular interval of directions—may be probed as candidate beams to determine which beam should be initially selected.

Using the concept of which beams provide coverage areas close to each other for selection for beam tracking may typically comprise considering beams that have coinciding and/or overlapping and/or adjacent coverage areas as the currently used beam as candidate beams—possibly together with beams that are angularly adjacent to the currently used beam—and probing such candidate beams to determine which beam should be selected when performance of the currently used beam deteriorates.

Such approaches typically make the beam selection more efficient (e.g., in terms of time and/or overhead signaling) than for other approaches. Furthermore, the probability of connection loss may be reduced compared to other approaches, since a better suited beam can be found more quickly when performance of the currently used beam deteriorates.

If a connection loss occurs, the time to re-establishment may be is reduced, and the probability of successful re-establishment may be increased. This is due to that re-establishment may be initiated by probing beam(s) that provide coverage areas close to the one where the connection was lost instead of wide beam probing. Since wide beams typically has shorter range than narrow beams, narrow beams (with proper coverage area) are more likely to have sufficient signal strength for re-establishment than wide beams.

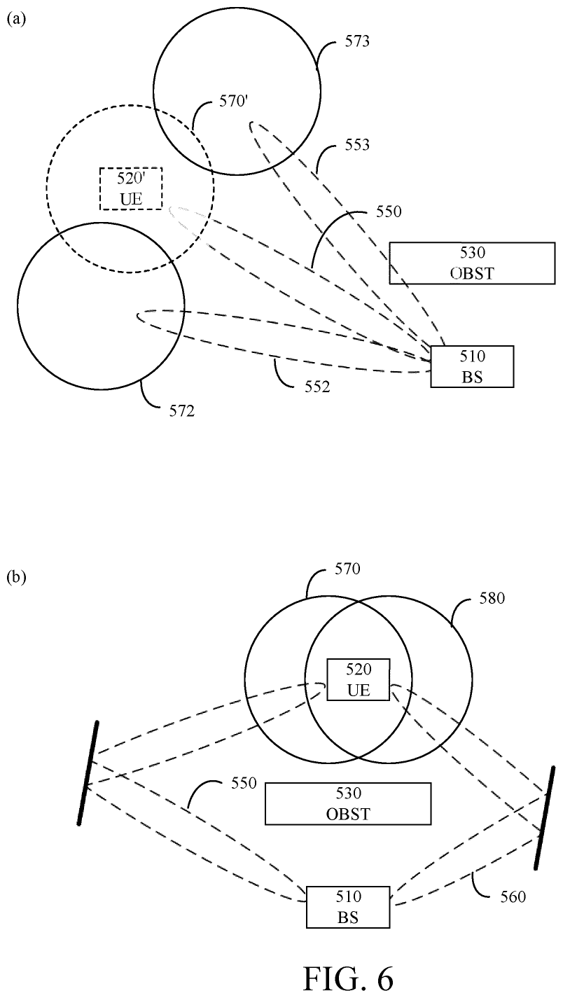

The concept described above is exemplified in FIGS. 5 and 6 using the context of beam tracking.

FIG. 5 schematically illustrates an example scenario where some embodiments may be applicable. In similarity with FIG. 3, an obstacle (OBST) 330 obstructs or blocks the radio signal between two communication entities; a base station (BS) 310 and a user equipment (UE) 320. Thus, there is no beam that can be used for line-of-sight communication between the BS 310 and the UE 320. Two radio reflectors 551, 561 are used in FIG. 5 to solve the problem caused by the obstacle 530. The radio reflector 551 causes a beam 550 to be reflected toward the area of location of the UE 520, and the radio reflector 561 causes a different beam 560 to be reflected toward the area of location of the UE 520. Thus, the beams 550, 560 and their associated radio reflectors 551, 561 provide redundancy coverage for the area of location of the UE 520. Also shown are two beams 552, 553 that are adjacent to the beam 550 (i.e., beams 550, 552, 553 are spatially close to each other in the angular dimension).

FIG. 6 schematically illustrates two different approaches (a) and (b) that may be used in an example beam tracking scenario according to some embodiments. The example beam tracking scenario of FIG. 6 builds on the beam-forming situation in FIG. 5 and assumes that beam 550 is currently used for communication with the UE 520.

One goal of the beam tracking is to determine a suitable beam to switch to when performance of the currently used beam deteriorates. To this end, probing on other beams may be performed. For efficiency (e.g., in relation to time and/or overhead signaling), only a subset of the available beams is typically probed in beam tracking. The approaches (a) and (b) of FIG. 6 exemplify how such a subset may be formed.

Approach (a) is similar to a classical approach where the beams 552, 553 that are adjacent to the currently used beam 550 are probed. This approach would be suitable, for example, if the currently used beam 550 provided line-of-sight coverage for the area of location of a UE 520′. Then, the coverage areas 572, 573 provided by the adjacent beams 552, 553 would typically be adjacent to and/or overlapping the coverage area 570′. Thereby, it can be assumed that it is probable that one of the adjacent beams 552, 553 is suitable for switching to when performance of the beam 550 deteriorates. However, this assumption may be less accurate in scenarios with one or more radio reflectors, since the coverage areas of adjacent beams are not necessarily adjacent in such scenarios.

Approach (b) illustrates an approach where closeness of coverage areas—rather than closeness of beams in the angular dimension—is a condition for determining which beams to probe. According to this approach, beam 560 is probed despite it being not at all adjacent to the currently used beam 550. This is because the coverage area 580 provided by the beam 560 is adjacent to and overlapping the coverage area 570 provided by beam 550 via its associated radio reflector. Thereby, it can be assumed that it is probable that beam 560 is suitable for switching to when performance of the beam 550 deteriorates; possibly more so than any of the beams adjacent to beam 550.

According to some embodiments, the approach exemplified by (b) of FIG. 6 may be applied for beam tracking when one or more radio reflectors are used. In some embodiments, a combination of the approaches exemplified by (a) and (b) of FIG. 6 may be applied for beam tracking when one or more radio reflectors are used (e.g., probing beams that are adjacent to the currently used beam in the angular dimension, as well as other beams with coverage areas adjacent to and/or overlapping the coverage area(s) of the currently used beam).

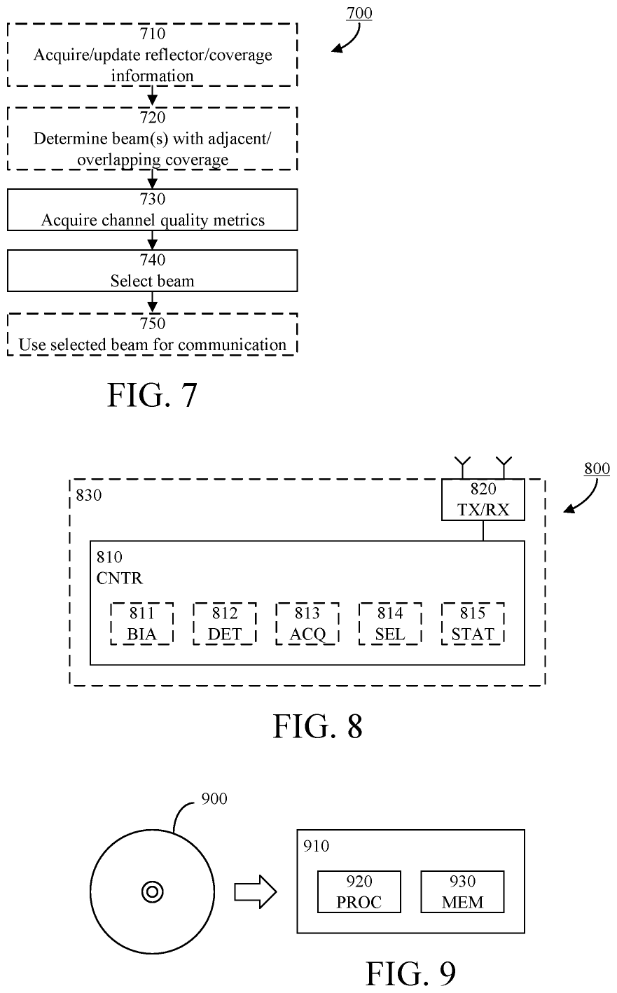

FIG. 7 illustrates an example method 700 according to some embodiments. The method 700 is a wireless communication method. The method 700 may be performed by a radio access node (e.g., any of the base stations 110, 310, 410, 510 illustrated in FIGS. 1-6). Furthermore, the method 700 is for selection of a beam for communication with a device (e.g., any of the user equipments 120, 320, 420, 520 illustrated in FIGS. 1-6).

Generally, when a radio access node is referred to herein, it is meant to encompass any suitable radio access nodes. Examples include network nodes, base stations (BS), radio units (RU), distributed units (DU), evolved NodeBs (eNB), access points (AP)—e.g., compliant with an IEEE 802.11 standard, etc. Typically, the radio access node comprises, or is otherwise associated with, an active antenna system (AAS) enabling the beam-forming.

Also generally, when a device is referred to herein, it is meant to encompass any suitable wireless communication device. Examples include user equipments (UE), stations (STA)—e.g., compliant with an IEEE 802.11 standard, etc.

The method 700 may be particularly useful when the communication with the device uses frequencies above 1 GHz (e.g., for communication in the 28 GHz frequency band and/or communication in the 39 GHz frequency band).

The beam selection of method 700 may, for example, be applied in initial beam selection and/or beam tracking. Further, the beam selection of method 700 is from a plurality of available beams (e.g., all available beams, or a subset thereof).

Typically, the available beams and the selected beam are communication beams (a.k.a., traffic beams, pencil beams, etc.). One typical feature of communication beams is that they are relatively narrow (e.g., compared to wide beams used for initial probing). Making a beam more narrow generally extends its range, which may be particularly beneficial when the transmission power is relatively low and/or the communication frequency is relatively high.

In step 730, channel quality metrics are acquired for available beams providing coverage for an area of location of the device.

At least one of the available beams is associated with a radio reflector which is specifically arranged to enable the associated beam to provide coverage for the area of location of the device via the radio reflector (e.g., by letting the radio reflector extend throughout a Fresnel zone for the radio access node and the device). To this end, the method 700 may be particularly useful when a radio signaling line of sight between the radio access node and the area of location of the device is obstructed.

As elaborated on above, the association between a beam and a radio reflector may generally be understood as there being a deliberate mapping between the beam, the radio reflector, and the resulting coverage area.

Knowledge of which beams provide which coverage areas may take any suitable form. For example, the knowledge may be provided as an association between two or more of a beam, a radio reflector, and an area of location (e.g., a coverage area). Alternatively or additionally, the knowledge may be provided by associating a beam with its virtually adjacent beams (the ones that have coinciding/overlapping/adjacent coverage areas) instead of—or in addition to—the association with its adjacent beams (the ones that are spatially adjacent to each other in the angular dimension).

Knowledge of which beams provide which coverage areas may preferably be available to the radio access node. One way to enable this is illustrated by optional step 710, where information indicative of beam coverage and/or radio reflector association is acquired for at least one available beam. For example, the information may comprise associations between beam pairs that provide adjacent and/or overlapping and/or coinciding coverage. Such beam pairs may be denoted as virtually adjacent beams in some embodiments.

The acquisition of step 710 may be embodied in any suitable way. For example, the information may be acquired at installation of the radio reflector and/or of the radio access node (e.g., by reception of a system information message, by reception of an input message provided by an installer, etc.). Alternatively or additionally, the information may be acquired and/or updated by collecting statistics regarding beam usage during operation. Such statistics may be used by a suitable machine learning algorithm, for example, to determine which beams provide adjacent and/or overlapping and/or coinciding coverage. Example suitable machine learning algorithms include algorithms trained on an initial set of existing data (e.g., using the k nearest neighbors (KNN) approach) and algorithms applying continuous learning based on dynamically collected data (e.g., using the k means algorithm).

The statistics may be any suitable statistic. Some useful examples include statistics regarding which beam pairs are involved in successful beam switching events, which beam pairs are involved in unsuccessful beam switching events (e.g., connection losses), and which beam pairs are involved in connection re-establishment (e.g., following connection loss). A beam pair involved in a successful beam switching event might be classified as virtually adjacent. A beam pair involved in an unsuccessful beam switching event might be classified as not virtually adjacent, and may be defined as the beam that was active when the event occurred and the beam to which switching was attempted. A beam pair involved in a connection re-establishment might be classified as virtually adjacent, and may be defined as the beam that was active when the connection loss occurred and the beam for which re-establishment was accomplished.

In some embodiments, multiple available beams are associated with corresponding radio reflectors to provide coverage for the area of location of the device via the radio reflector. As explained above, this may be particularly beneficial when at least one radio reflector has imperfections causing partial impairment of the coverage provided by the associated beam for the area of location of the device. Imperfections may take any possible form. Example imperfections include uneven surfaces.

Thus, according to some embodiments, two or more available beams are associated with respective radio reflectors, each radio reflector being specifically arranged to enable the respectively associated beam to provide coverage for the area of location of the device via the radio reflector. For example, the two or more available beams may be enabled by the respective radio reflectors to provide redundancy coverage for the area of location of the device. As explained above, the respective areas of the coverage provided by the two or more available beams via the respective radio reflector may be at least partially overlapping (e.g., coinciding, or substantially coinciding).

Typically, different radio reflectors are associated with different available beams for coverage of the area of location of the device.

The area of location of the device may be defined as the precise location of the device or as a physical area that comprises the precise location of the device. That a beam provides coverage for the area of location of the device may be defined as one or more of: the coverage area of the beam coinciding with the physical area that comprises the precise location of the device, the coverage area of the beam overlapping the physical area that comprises the precise location of the device, the coverage area of the beam being adjacent to the physical area that comprises the precise location of the device, the coverage area of the beam comprising the precise location of the device, and the coverage area of the beam being adjacent to the precise location of the device.

Typically, step 730 may comprises probing the available beams that provide coverage for the area of location of the device. Probing may be performed using any suitable technique. One example probing technique comprises transmitting reference signals (e.g., CSI-RS) on the probed beams and receiving a report from the wireless communication device that indicates the channel quality metrics for probed beams.

The channel quality metric may have any suitable form. Examples include signal strength, received signal strength indicator (RSSI), reference signal received power (RSRP), reference signal received quality (RSRQ), signal-to-interference ratio (SIR), signal-to-interference-and-noise ratio (SINR), channel quality indicator (CQI), channel state information (CSI), etc.

The channel quality metrics may be acquired for all available beams providing coverage for the area of location of the device, or for only some of the available beams that provide coverage for the area of location of the device (i.e., those statistically most prone to be suitable in the current situation).

Furthermore, channel quality metrics may be acquired also for other available beams than those providing coverage for the area of location of the device. For example, when a combination of approaches (a) and (b) of FIG. 6 is applied, channel quality metrics may be acquired for beams 552, 553, and 560 when beam 550 is the currently used beam. This is beneficial, for example, if it not known whether beam 550 is communicating with a device positioned as UE 520′ or as UE 520.

In step 740 one of the available beams is selected based on the acquired channel quality metrics. The selection of step 740 based on the channel quality metrics may be in accordance with any suitable approach. Examples include selecting the beam with best channel quality metric (e.g., highest signal strength, highest SIR, etc.), and selecting a beam with channel quality metric that meet a selection criterion such as a threshold value (e.g., signal strength above a signal strength threshold, SIR above a SIR threshold, etc.).

In optional step 750, the selected beam is used for communication with the device (transmission and/or reception relating to the device).

The selection of method 700 may be selection of an initial beam (e.g., at connection setup). Alternatively or additionally, the selection of method 700 may be comprised in a beam tracking procedure.

Using the selection of an initial beam as an example, the method 700 may comprise determining available beams that provide coverage within an area of location of the device (e.g., determined by wide beam probing). The determined available beams are then used as the available beams providing coverage for the area of location of the device in steps 730 and 740, to select a suitable initial beam.

Using the beam tracking procedure as an example, the method 700 may comprise determining available beams that provide coverage adjacent to and/or overlapping the coverage of the active beam (i.e., the beam currently used for communication with the device), as illustrated by optional step 720. The determined available beams are then used as the available beams providing coverage for the area of location of the device in steps 730 and 740, to select a suitable beam to switch to (e.g., when performance of the active beam deteriorates).

It should be noted that any suitable feature described herein may be applicable in the context of method 700, even if not explicitly mentioned in relation thereto.

According to some embodiments, multiple radio reflectors are used, which are separated in location such they reflect different traffic beams from the radio access node. This enables the radio access node to select the best beam (i.e., the best radio reflector) for transmission to a device in a location not covered by a line-of-sight beam.

During use of one beam and corresponding radio reflector, other beams may be monitored using beam tracking. If the interference situation changes when using one beam and corresponding radio reflector (e.g., due to movement of the device and/or of the radio reflector), a beam switch may be performed based on the beam tracking monitoring.

According to some embodiments, the radio access node is aware of which beams use which radio reflector for coverage of an area (e.g., a NLOS area). Such knowledge enables the radio access node to probe the most relevant beams (those having similar coverage areas as the current beam) when performing beam tracking.

FIG. 8 schematically illustrates an example apparatus 800 according to some embodiments. The apparatus 800 is for wireless communication by a radio access node. For example, the apparatus 800 may be comprised in a radio access node 830.

The apparatus is for selection of a beam for communication with a device, wherein the selection is from a plurality of available beams. For example, the apparatus may be configured to cause performance of (e.g., perform) one or more of the steps described in connection with method 700 of FIG. 7.

The apparatus 800 comprises a controller (CNTR; e.g., controlling circuitry or a control module) 810.

The controller 810 is configured to cause acquisition of channel quality metrics for available beams providing coverage for an area of location of the device, wherein at least one of the available beams is associated with a radio reflector which is specifically arranged to enable the associated beam to provide coverage for the area of location of the device via the radio reflector (compare with step 730 of FIG. 7).

To this end, the controller 810 may comprise, or be otherwise associated with (e.g., connected, or connectable, to) an acquirer (ACQ; e.g., acquiring circuitry or an acquisition module) 813. The acquirer 813 may be configured to acquire the channel quality metrics for available beams providing coverage for the area of location of the device.

The controller 810 is also configured to cause selection of one of the available beams based on the acquired channel quality metrics (compare with step 740 of FIG. 7).

To this end, the controller 810 may comprise, or be otherwise associated with (e.g., connected, or connectable, to) a selector (SEL; e.g., selecting circuitry or a selection module) 814. The selector 814 may be configured to select one of the available beams based on the acquired channel quality metrics.

The controller 810 may be configured to cause the selected beam to be used for communication with the device (compare with step 750 of FIG. 7).

The beam selection may be selection of an initial beam (e.g., at connection setup) and/or may be comprised in a beam tracking procedure.

In some embodiments, the controller 810 may be further configured to cause determination of available beams that provide coverage within an area of location of the device and/or determination of available beams that provide coverage adjacent to and/or overlapping the coverage of the active beam (compare with step 720 of FIG. 7). The determined beams may be used as beams for which the channel quality metrics are acquired.

To this end, the controller 810 may comprise, or be otherwise associated with (e.g., connected, or connectable, to) a determiner (DET; e.g., determining circuitry or a determination module) 812. The determiner 812 may be configured to determine the available beams that provide coverage within an area of location of the device, and/or that provide coverage adjacent to and/or overlapping the coverage of the active beam.

In some embodiments, the controller 810 may be further configured to cause acquisition of information indicative of beam coverage and/or radio reflector association for at least one available beam (compare with step 710 of FIG. 7).

To this end, the controller 810 may comprise, or be otherwise associated with (e.g., connected, or connectable, to) a beam information acquirer (BIA; e.g., beam information acquiring circuitry or a beam information acquisition module) 811. The beam information acquirer 811 may be configured to acquire the information indicative of beam coverage and/or radio reflector association for at least one available beam.

As explained above, the acquisition of information indicative of beam coverage and/or radio reflector association may be at installation of a radio reflector, and/or at installation of the radio access node, and/or based on statistics regarding beam usage during operation.

In some embodiments, the controller 810 may be further configured to cause updating of information indicative of beam coverage and/or radio reflector association for at least one available beam (compare with step 710 of FIG. 7), e.g., by collection of statistics regarding beam usage during operation.

To this end, the controller 810 may comprise, or be otherwise associated with (e.g., connected, or connectable, to) a statistics collector (STAT; e.g., statistics collecting circuitry or a statistics collection module) 815. The statistics collector 815 may be configured to collect the statistics regarding beam usage during operation for updating (and or initial acquisition) of the information indicative of beam coverage and/or radio reflector association for at least one available beam.

The apparatus 800 may further comprise, or be otherwise associated with (e.g., connected, or connectable, to) a transceiver (TX/RX; e.g., transceiving circuitry or a transceiver module) 820. The transceiver 820 may, for example, be configured to perform one or more of the following actions: transmission of reference signaling on beams to be probed, reception of reports indicative of channel quality metrics, reception of information contributing to the statistics regarding beam usage during operation, reception of messages comprising information indicative of beam coverage and/or radio reflector association for available beams, and communication with the device (transmission and/or reception).

It should be noted that any suitable feature described herein (e.g., in connection with FIG. 7) may be applicable in the context of apparatus 800, even if not explicitly mentioned in relation thereto.

As already exemplified, the apparatus 800 and/or the radio access node 830 may be comprised in a wireless communication system. The wireless communication system may further comprise one or more (e.g., two or more, or a plurality of) radio reflectors, wherein each radio reflector is specifically arranged to enable an associated beam to provide coverage for an area of location of the device via the radio reflector.

Such systems may be particularly useful for deployment in some geographically bounded communication environments. Examples of such geographically bounded communication environments include industrial environments, factory buildings, building sites, etc. In some embodiments, geographically bounded communication environments is a non-public communication environment.

Alternatively or additionally, the systems may be particularly useful for deployment in communication environments where natural reflections are scarce (e.g., not present). Examples of such environments include relatively large open spaces—indoors or outdoors—such as sports premises (e.g., arenas, stadiums, soccer fields etc.), air fields, large ships, oil platforms, etc.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a radio access node.

Embodiments may appear within an electronic apparatus (such as a radio access node) comprising arrangements, circuitry, and/or logic according to any of the embodiments described herein. Alternatively or additionally, an electronic apparatus (such as a radio access node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 9 illustrates an example computer readable medium in the form of a compact disc (CD) ROM 900. The computer readable medium has stored thereon a computer program comprising program instructions. The computer program is loadable into a data processor (PROC; e.g., a data processing unit) 920, which may, for example, be comprised in a radio access node 910. When loaded into the data processor, the computer program may be stored in a memory (MEM) 930 associated with, or comprised in, the data processor. According to some embodiments, the computer program may, when loaded into, and run by, the data processor, cause execution of method steps described herein (e.g., according to the method illustrated in FIG. 7).

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-36. (canceled)

37. A wireless communication method performed by a radio access node for selection of a beam for communication with a device, wherein the selection is from a plurality of available beams, the method comprising:
acquiring channel quality metrics for available beams providing coverage for an area of location of the device, wherein at least one of the available beams is associated with a radio reflector which is specifically arranged to enable the associated beam to provide coverage for the area of location of the device via the radio reflector; and
selecting one of the available beams based on the acquired channel quality metrics.

38. The method of claim 37, wherein two or more available beams are associated with respective radio reflectors, each radio reflector being specifically arranged to enable the respectively associated beam to provide coverage for the area of location of the device via the radio reflector.

39. The method of claim 38, wherein the two or more available beams are enabled by the respective radio reflectors to provide redundancy coverage for the area of location of the device, and/or wherein respective areas of the coverage provided by the two or more available beams via the respective radio reflector are at least partially overlapping.

40. The method of claim 37, wherein different radio reflectors are associated with different available beams for coverage of the area of location of the device.

41. The method of claim 37, wherein at least one radio reflector has imperfections causing partial impairment of the coverage provided by the associated beam for the area of location of the device.

42. The method of claim 37, wherein the selection is comprised in a beam tracking procedure.

43. The method of claim 42, wherein the beam tracking procedure comprises, for an active beam currently used for communication with the device:
determining available beams that provide coverage adjacent to, and/or overlapping, the coverage of the active beam, wherein the determined available beams are used as the available beams providing coverage for the area of location of the device.

44. The method of claim 37, further comprising acquiring information for at least one available beam, the information indicative of beam coverage and/or radio reflector association.

45. The method of claim 44, wherein the information comprises associations between beam pairs that provide adjacent and/or overlapping and/or coinciding coverage.

46. The method of claim 44, wherein the information is acquired at installation of the radio reflector and/or of the radio access node.

47. The method of claim 44, wherein the information is acquired and/or updated by collecting statistics regarding one or more of:
which beam pairs are involved in successful beam switching events;
which beam pairs are involved in unsuccessful beam switching events; and
which beam pairs are involved in connection re-establishment.

48. The method of claim 37, wherein the communication with the device uses frequencies above 1 GHz.

49. The method of claim 37, wherein a radio signaling line of sight between the radio access node and the area of location of the device is obstructed.

50. The method of claim 37, wherein the radio reflector extends throughout a Fresnel zone for the radio access node and the device.

51. A non-transitory computer readable medium storing a computer program comprising program instructions, the computer program being loadable into a data processing unit and configured to cause execution of the method of claim 37 when the computer program is run by the data processing unit.

52. An apparatus for wireless communication by a radio access node, the apparatus being for selection of a beam for communication with a device, wherein the selection is from a plurality of available beams, the apparatus comprising controlling circuitry configured to cause:
acquisition of channel quality metrics for available beams providing coverage for an area of location of the device, wherein at least one of the available beams is associated with a radio reflector which is specifically arranged to enable the associated beam to provide coverage for the area of location of the device via the radio reflector; and
selection of one of the available beams based on the acquired channel quality metrics.

53. A radio access node comprising the apparatus of claim 52.

54. A system comprising:
the radio access node of claim 53, and
a radio reflector specifically arranged to enable an associated beam to provide coverage for the area of location of the device via the radio reflector.

55. The system of claim 54, wherein the at least one radio reflector comprises a plurality of radio reflectors, each radio reflector being specifically arranged to enable a respectively associated beam to provide coverage for the area of location of the device via the radio reflector.

56. The system of claim 54, for deployment in a geographically bounded communication environment.
